(19) United States
(12) Patent Application Publication
(10) Pub. No.: US 2008/0011327 A1
(43) Pub. Date: Jan. 17, 2008

(54) CLEANING SOLUTION FOR USE IN CLEANING THE AIR INTAKE SYSTEM OF A DIESEL VEHICLE

(75) Inventors: Kenneth E. Shriner, Wichita, KS (US); Harold E. Erwin, Augusta, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: BG PRODUCTS, INC., Wichita, KS (US)

(21) Appl. No.: 11/780,173

(22) Filed: Jul. 19, 2007

Related U.S. Application Data
(63) Continuation-in-part of application No. 10/722,302, filed on Nov. 25, 2003, now abandoned.
(60) Provisional application No. 60/478,522, filed on Jun. 13, 2003.

(51) Int. Cl. B08B 9/043; C11D 3/00; C11D 3/20; C11D 3/43

(52) U.S. Cl. 134/22.19; 510/185

(57) ABSTRACT

A cleaning solution, which is particularly useful in cleaning the air-intake system of an EGR-valve-equipped diesel engine, includes a high-polarity solvent and low polarity solvent. The solution may also include a surfactant, a fatty amide, and a functional ketone. The cleaning solution is applied to the air intake system while the diesel engine is running, thereby drawing the cleaning solution into the air intake system to clean the same. The EGR valve is removed and replaced with a vessel in which a pressure drop is created. The pressure drop creates sufficient vacuum so that cleaner may be administered into the air-intake duct of the vehicle.

### CROSS-REFERENCE TO RELATED APPLICATIONS

This application, having attorney docket number BGPI.136480, is a continuation-in-part of pending application Ser. No. 10/722,302, attorney docket number BGPI.108186, filed Nov. 25, 2003, which claims the benefit of U.S. Provisional Application No. 60/478,582, filed Jun. 13, 2003. All of the aforementioned applications are incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention relates generally to the field of cleaning the engine systems of diesel vehicles. More specifically, the present invention relates to a method of cleaning the air intake systems of diesel vehicles. Even more specifically, the present invention relates to the use of a device to introduce carefully controlled amounts of cleaning solution into the air supply system such that the entire air supply system is cleaned. The device is configured to create a vacuum within the air intake system such that the cleaning solution passing therein remains, substantially airborne, and thereby distributed throughout the entire air supply system.

2. Description of the Related Art

Motor vehicle engines, whether they use gasoline or diesel fuel, have three fundamental components that participate in the combustion process—an air intake duct, a combustion chamber (or chambers), and an exhaust duct. It used to be that both gasoline and diesel engines would intake air (containing oxygen) in through the air intake system, and for gasoline engines, fuel would be mixed with the air prior to entering the combustion chamber. With respect to the traditional diesel engine, the air was typically injected directly into the combustion chamber. For both systems, however, only fresh, uncombusted air would be present in the entire system upstream from the combustion chamber. After combustion, undesirable, contaminating hydrocarbons (“soot”) would form as a by-product of combustion and cling to components in the combustion chamber and exhaust system. With respect to the combustion chamber, the intake and exhaust valves, piston head, and side walls would be undesirably lined with soot. With respect to the exhaust system, its components would also be covered.

In order to remove this soot, cleaners could be mixed with the fuel before it was introduced into the combustion chamber. The introduction of cleaners into the combustion chamber effectively cleaned the combustion chamber and the down stream exhaust system. This method, however, did not clean the air intake system as it is upstream of the combustion chamber. Because the air intake systems were only exposed to clean, outside air, they did not require frequent cleaning.

Later, exhaust gas recirculation (“EGR”) was introduced into gasoline engines. An EGR system takes a portion of the combusted-exhaust gas from the exhaust system, and loops this portion back into the air intake duct of the vehicle. Once reintroduced into the air intake duct, and mixed with fresh air, this portion of already combusted air serves to make the overall combustion process less environmentally harmful.

Though great for the environment, this recirculation process had a major practical disadvantage in that it resulted in soot being recirculated along with the exhaust gas. This now introduced soot or dirty air into the air intake system for the first time. It also introduced soot into the new valve that made exhaust gas recirculation possible, i.e. the EGR valve. As a result, now that soot was present upstream from the combustion chamber, new methods had to be developed to clean soot from these places. The prior art methods of simply adding cleaner into the fuel would not work because the cleaning solution would not contact the upstream air intake system.

To overcome this obstacle, technicians used several different methods. One such method involved spraying a cleaner into the air intake system to “decarb” at the point of air introduction. This procedure didn't work very well, because it didn't adequately clean the EGR valve (again, the point at which the recirculated air is introduced into the air intake system). To overcome this, technicians began spraying cleaners, either alternatively or additionally, into the EGR valve itself. The vacuum created by gasoline engines drew in enough air volume with adequate velocity to carry the cleaner through the EGR valve for cleaning purposes. These methods are still the most effective way to clean gasoline engines with EGR systems.

Recently, however, EGR systems have also been added to diesel engines. This has created quite a dilemma for technicians wishing to adequately clean these new systems because the combustion chambers in diesel engines create a weaker vacuum than those in gasoline engines. As a result, the prior art methods of simply spraying cleaner in through the EGR valve will not work because there is not enough vacuum to draw the cleaner in through the system. Thus, there is a need in the art for a cleaning technique that permits the cleaning of an EGR system and air intake system on a diesel engine.

### SUMMARY OF THE INVENTION

The present invention includes a method, an apparatus and a cleaning solution that provide for the cleaning of air intake system and the EGR valve of a diesel engine having an EGR system, while avoiding many of the problems inherent in the prior art. In short, the apparatus causes a pressure drop within the diesel engine's air intake system. The pressure drop increases the velocity of the air flowing through the system. The increased air velocity artificially increases the vacuum and helps carry the cleaning solution, which is injected into the air stream, throughout the air intake system, thereby completely cleaning the system without the need to manually scrape off any deposits. The apparatus also creates additional turbulence within the air flowing through the intake system. This increases the distribution of the cleaning solution through all parts of the air intake system and ensures contact therewith. The apparatus also carefully controls the rate the cleaning solution is injected into the diesel engine's air intake system so that the engine is not harmed during the cleaning process. While prior art cleaning solutions can be used with the apparatus, a cleaning solution having a new chemical formulation which is particularly useful in cleaning diesel engines, and which has been specifically designed to be used with the apparatus disclosed herein, is also provided.

### BRIEF DESCRIPTION OF THE SEVERAL VIEWS OF THE DRAWINGS

The present invention is described in detail below with reference to the attached drawing figures, wherein:

FIG. 1 is a view of an EGR-equipped air intake system with an EGR valve removed in preparation for cleaning contaminants off the inside surface of an air-intake duct;

FIG. 2 is an overview of the cleaning system with the parts of the diesel engine air intake system shown;

FIG. 3 is an exploded view of a dispersion component and a liquid flow controller illustrating how the two components and related parts are assembled;

FIG. 4. is a side elevational view of the dispersion component and liquid flow controller assembled together;

FIG. 5. is a perspective view of the dispersion component;

FIG. 6. is a side elevation view of the dispersion component;

FIG. 7 is a cross sectional view of the dispersion component taken along the line 7-7 of FIG. 5;

FIG. 8 is a bottom perspective view of an EGR valve port adapter;

FIG. 9 is a left side elevational view of an EGR valve port adapter of FIG. 8;

FIG. 10 is a rear side elevational view of the EGR valve port adapter of FIG. 8;

FIG. 11 is a cross-sectional view of the EGR valve port adapter taken along the line 11-11 of FIG. 10;

FIG. 12 is a cross-sectional view of the EGR valve port adapter taken along the line 12-12 of FIG. 10;

FIG. 13 is a perspective view of the mouth adapter; and

FIG. 14 is a cross-sectional view of the mouth adapter taken along the line 14-14 of FIG. 13.

### DETAILED DESCRIPTION OF THE INVENTION

The present invention includes an apparatus that allows a user to clean the air intake system 100 of a diesel engine (not shown) having an EGR system and avoid the problems inherent in the prior art. The apparatus causes a pressure drop within the diesel engine's air intake system 100, thereby increasing the velocity of the air flowing through the system. The increased air velocity helps carry a cleaning solution, which is injected into the air stream, throughout the air intake system. As a result the entire air intake system is cleaned without the need to manually scrape off deposits.

The decrease in pressure within the air intake system 100 is created by limiting the amount of air the engine is allowed to draw in while running. This is done by plugging one of the normally two air-intake system openings and placing a vacuum control device 300 on the other opening. While the engine is running, cleaning solution (not shown) is injected into the vacuum control device 300 where it is mixed with inlet air that is being drawn into the vacuum control device. Because of the increased air velocity created by the lower pressure within the air intake system 100, the cleaning solution is distributed throughout the air intake system 100 resulting in improved cleaning. Without the increased air velocity, the cleaning solution would not be carried throughout the air-intake system.

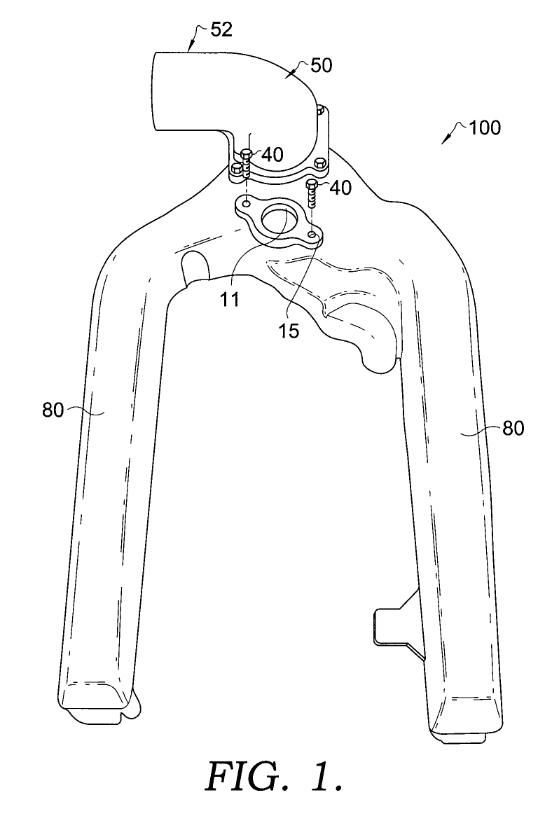

FIG. 1 shows a typical air intake system 100 for a diesel engine (not shown). Air is supplied to the air-intake system 100 through two openings. The first opening is the primary air intake 50, which is normally coupled to an air hose (not shown) with an air filter (not shown) located at the end of the hose. The second opening is the EGR valve port 11. Normally an EGR valve is coupled with the EGR valve port 11; however, for clarity, the EGR valve has been removed. Air from both openings combine in a duct 80 that leads to the combustion chamber of the engine. Normally, the EGR valve is attached to the EGR valve port 11 by bolts 40 which are received through apertures 15.

In order that the present invention be implemented, the air hose (not shown) is uncoupled from a mouth 52 of the primary air intake 50. The EGR valve is also removed from the EGR valve port 11 by removing bolts 40. Once removed, the EGR valve will be thoroughly cleaned manually (separately from the other processes described here) in a manner known to those skilled in the art. The EGR valve is then set aside, pending reattachment. The EGR valve port 11, the mouth thereof now exposed in the absence of EGR valve, will usually be visibly dirty. This is especially true if the vehicle has been driven for significant mileage. The technician will notice substantial build-up of hydrocarbons on the cylindrical interior surface of the EGR valve port 11. This buildup is often found throughout the air intake system 100 in varying concentrations.

This build-up poses many problems. The prior art method of cleaning this soot, was to either brush or chisel it away with hand-held tools. This technique, however, is risky, because dislodged particles commonly become knocked into duct 80 and ultimately end up being drawn into the combustion section of the engine. Because they are very hard and relatively large with respect to what can be tolerated by the combustion systems of the engine, significant engine damage is a possibility. The present invention avoids this risk by removing the impurities using a cleaning solution that dissolves the solids so they can pass safely through the combustion chamber.

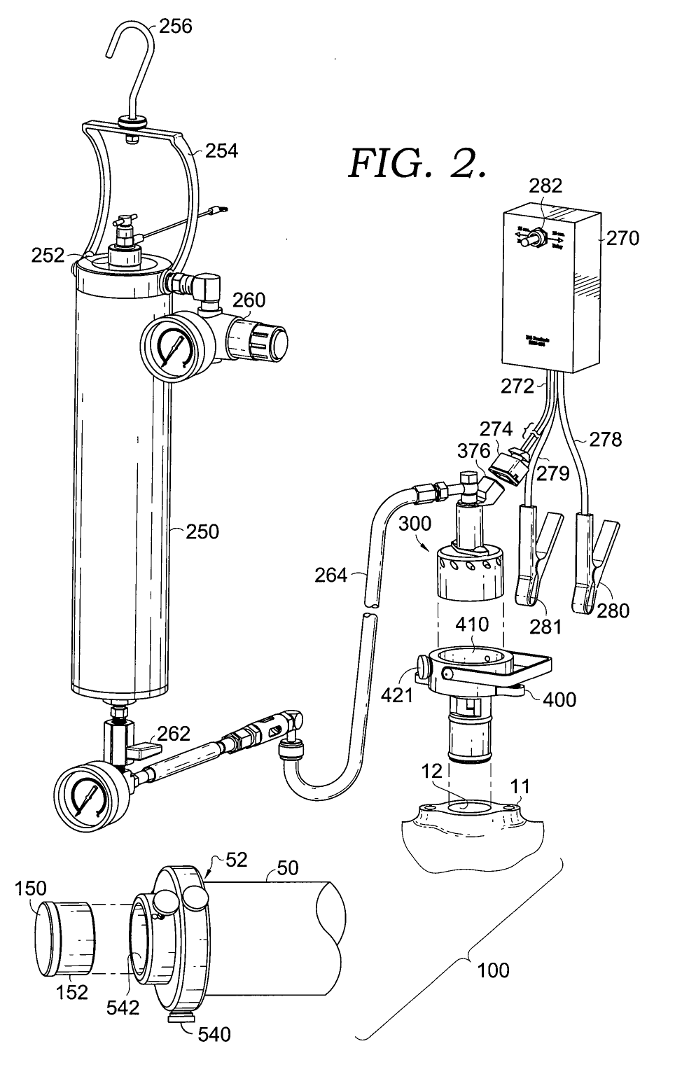

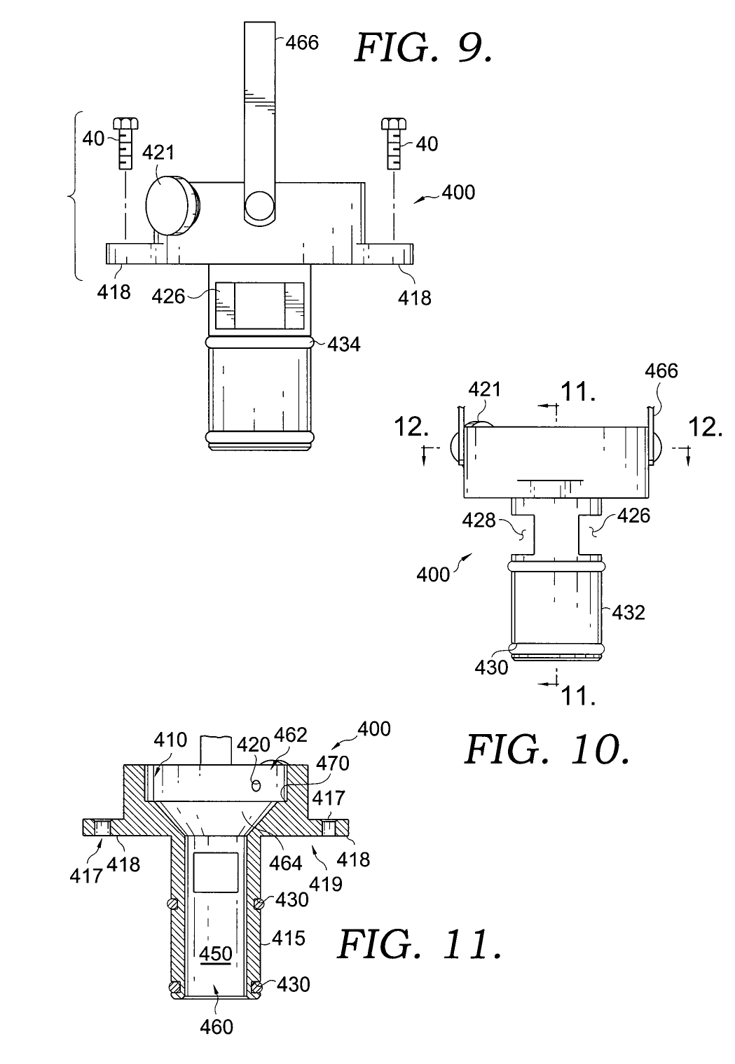

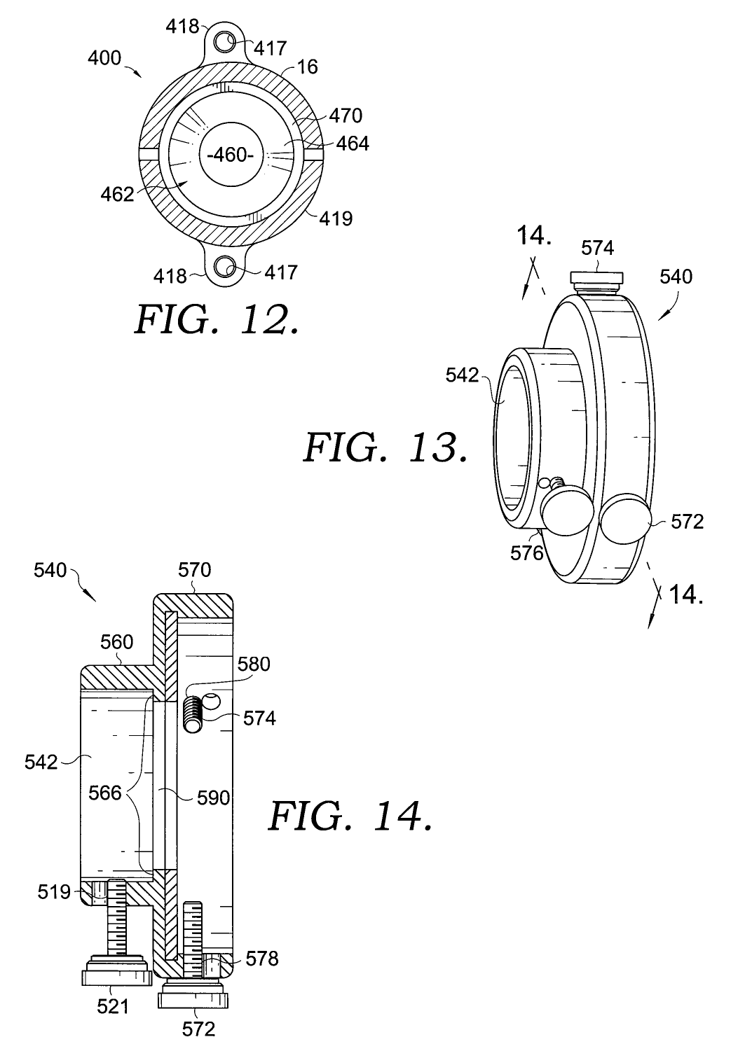

FIG. 2 shows the equipment that will be assembled to deliver the cleaning solution into the air intake system 100, thereby removing soot from the wall of the system. First, an EGR valve port adaptor 400 will be bolted onto the EGR valve port 11 in the same fashion as the EGR valve would normally be attached. The EGR valve port adapter 400 will be described in more detail below with reference to FIGS. 8-12. A vacuum control device 300 may then be coupled with the installed valve port adapter 400. A receiving socket 410 of the EGR valve port adapter 400 is configured to receive either a plug 150 or the vacuum control device 300, depending on the area to be cleaned.

Next, a primary air intake adapter 540, described in more detail with reference to FIGS. 13 and 14, may be attached to the mouth 52 of the primary air intake 50. A receiving socket 542 in the primary air intake adapter 540 is configured to receive either the plug 150 or the vacuum control device 300, depending, again, on the area to be cleaned. As explained in more detail hereafter, the plug 150 is placed in the primary air intake adapter 540 when the vacuum control device 300 is connected to the EGR valve port adapter 400. After the air intake system 100 is cleaned through the EGR valve port 11, the process is repeated with the plug 150 being placed in the EGR valve port adapter 400 and the vacuum control device 300 being installed in the primary air intake adapter 540. This time, however, the cleaning solution is injected through the primary air intake 50.

The cleaning solution to be inserted into the system is maintained under pressure in a cleaning solution vessel 250. Pressure is maintained in the cleaning solution vessel through supplied air (not shown) that enters the vessel through a regulator 260. The regulator 260 maintains pressure in the cleaning solution vessel 250 between 5 and 120 psig. In a preferred embodiment the pressure is maintained between 60 and 80 psig. The cleaning solution enters the cleaning solution vessel 250 through a sealable opening 252. A handle 254 with a hanger 256 is connected to the top of the cleaning solution vessel 250 for the convenience of the technician. The pressure provides the motive force for the solution to flow from the cleaning solution vessel 250 through a shutoff valve 262 to the vacuum control device 300 by way of a hose 264. A preferred composition for this cleaner will be described hereinafter.

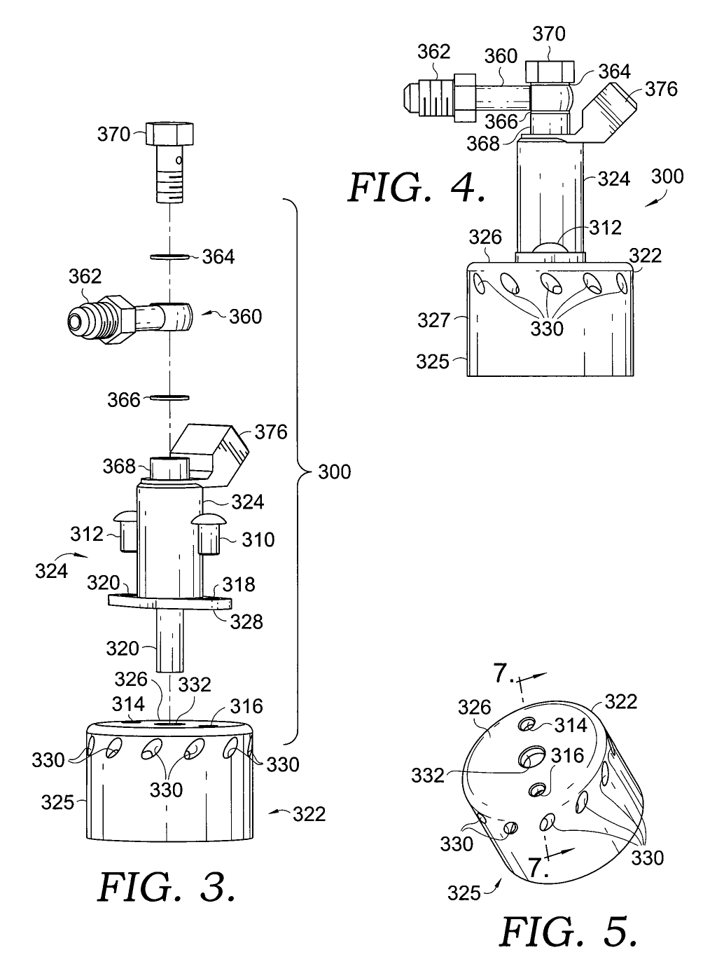

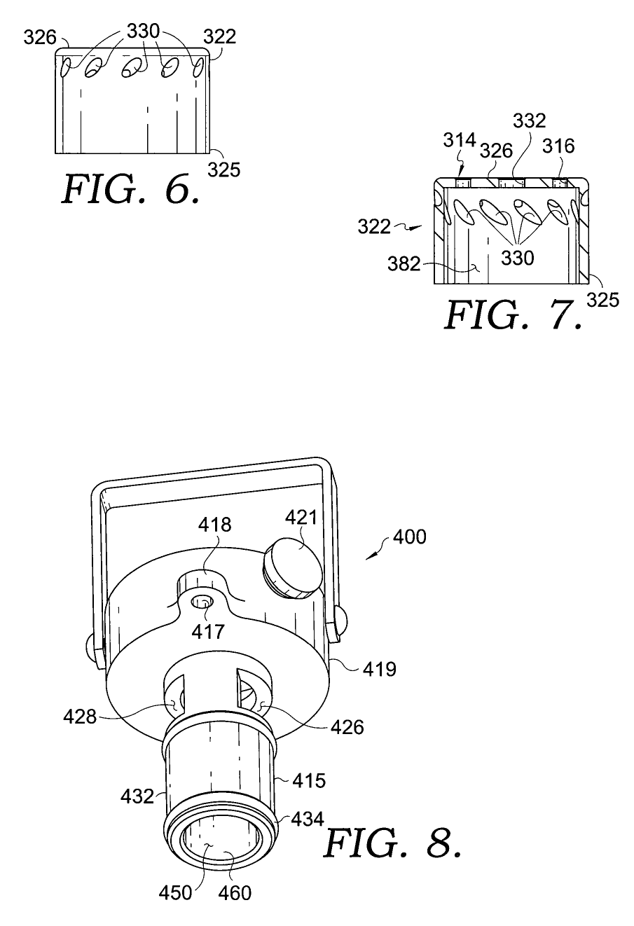

The vacuum control device 300, described in more detail with reference to FIGS. 3-7, consists of a dispersion device 322 and a liquid flow controller 324. The liquid flow controller 324 controls the flow of cleaning solution into the dispersion device 322 where it is mixed with air, as hereinafter explained. The liquid flow controller 324 is controlled by a control panel 270. The control panel 270 is electrically connected to the liquid flow controller 324 through control wires 272 attached to the control panel 270 on one end and a plug 274 on the other. The liquid flow controller 324 has a receptacle 376 adapted to mate with plug 274. In one embodiment, power is supplied to the control panel 270 through leads 278 and 279 that are attached to the positive and negative poles on a battery (not shown) by way of clamps 280 and 281. It is well understood by those of ordinary skill in the art that power could be supplied to the control panel 270 in a variety of different manners, all of which are contemplated to be within the scope of the invention.

In one embodiment, the control panel 270 is pre-programmed to feed the cleaning solution through the liquid flow controller 324 at a high rate and a low rate. The control panel 270 also has an “off” setting where the liquid flow controller 324 remains in the closed position.

In one embodiment, the low rate setting delivers approximately a quart an hour to the system, while the high rate delivers approximately a quart every 45 minutes. Feeding cleaning solution into the engine at a rapid rate can cause engine damage. The low rate is low enough that no engine problems should be caused regardless of the amount of fouling in the engine. The high rate should work with most engines, under most conditions. However, if the engine begins to knock or chatter while feeding solution at the high rate, the solution flow should be turned off. Once the engine begins to run without clattering or knocking, the solution may be delivered again, but at the lower setting.

In one embodiment the rate of delivery is controlled via a knob 282 on the exterior of the control panel 270. It is well understood by those having ordinary skill in the art that there are many ways to receive rate input from the user including but not limited to a switch, a dial, a keypad, or a touch screen. Any known means of receiving input from the user is contemplated to be within the scope of this invention. Further, even though two rate settings are discussed in the preferred embodiment, described above, any number of rate settings or a variable rate control device could also be used.

It is also well understood that the rate of flow through liquid flow controller 324 can change depending on the pressure differential through the liquid flow controller 324. For this reason the regulator 260 should be sent to maintain the pressure in the cleaning solution vessel 250 to the pressure upon which the control panel 270 rate settings were based.

The details regarding adaptor 400 are disclosed in FIGS. 8-12. Adaptor 400 has an outwardly extending cylindrical portion 415 and a body 419 which is also cylindrical in the preferred embodiment. Cylindrical portion 415 defines a cylindrical opening 460 through cylindrical portion 415. Cylindrical portion 415 has a diameter that is slightly smaller than the diameter of the opening 12 in the EGR valve port 11. Cylindrical portion 415 has two slots 426 and 428 therein opposite each other adjacent the body 419. The slots 426, 428 are of sufficient depth to cut into a passage 450 through the adapter 300. Cylindrical portion 415 also has a pair of annular grooves 430 in an outer surface 432 thereof. The grooves 430 receive o-rings 434 to seal the connection when the adapter 400 is received in the air intake system 100. Body 419 has a pair of flanges 418. The flanges 418 have holes 417 therethrough for receiving the bolts 40 to attach the adaptor 400 to the EGR valve port 11.

The body 419 defines a receiving socket 462 which is slightly larger than the insertion section 325 of the vacuum control device 300 and the insertion section 152 of the plug 150. The body 419 also defines a cone shaped reducing section 464 which connects the receiving socket 462 with the cylindrical opening 460 and which together define the passage 450 through the adapter 400. A threaded hole 420 is disposed radially through body 419 in order to receive a thumbscrew 421. The thumbscrew 421 is used to secure the vacuum control device 300 or the plug 150 in the receiving socket 462. A handle 466 is attached to the body 419 to facilitate removal of the adapter 400 from the EGR valve port 11 or the primary air intake adapter 540.

Vacuum-control device 300 is attached once adaptor 400 has been bolted onto flange 15 of EGR valve port 11. The details of the vacuum control device 300 are shown in FIGS. 3-7. The outside diameter of the insertion end 325 of the vacuum control device 300 is infinitesimally smaller than the inside diameter of the receiving socket 462 of the adaptor 400. These dimensions allow the insertion end 325 to be slidably received inside the receiving socket 462 defined by the body 419 of the adaptor 400 until the insertion end 325 reaches a ridge 470 within the receiving socket 462. Once the insertion end 325 has been abutted against the ridge 470, the device 300 is secured within the adaptor 400 by screwing in the thumbscrew 421. The tip of the thumbscrew 421 engages an outer surface 327 of the insertion end 325 of the vacuum control device 300. The vacuum control device 300 is now securely held within the adapter 400. The insertion end 152 of the plug 150 would be secured in the adapter 400 or the adapter 540 in substantially the same manner.

The functional features of device 300, illustrated in FIGS. 3-7, will now be described. Evident in FIG. 3 is that the device 300 is divided into two separate components. One is a dispersion device 322 and the other is a liquid flow controller 324. The liquid flow controller 324 is fixed to the dispersion device 322 by two bolts 310 and 312. The bolts 310, 312 are fed through holes 320 and 318 of a flange 328 at the base of the liquid flow controller 324 and into threaded holes 314 and 316 in the top section 326 of the dispersion device 322. A tube 320 protrudes from the liquid flow controller 324 through a hole 332 in the top of the dispersion device 322.

The liquid flow controller 324 has the ability to rapidly start and stop the flow of cleaning solution. In one embodiment, the liquid flow controller is a standard fuel injector. The liquid flow controller 324 receives an open/close signal from the control panel 270. In one embodiment, the cleaning solution is fed intermittently into the dispersion device 322 at a rate of on for three seconds and then off for three seconds. The liquid flow controller 324 has the electrical receptacle 376 that connects with the plug 274 of the wire 272 that carries the signal from the control panel 270.

The cleaning solution enters the liquid flow controller 324 through nozzle 368. Cleaning solution is fed into nozzle 368 by a banjo fitting 360 and banjo bolt 370. A washer 364 is used between the banjo fitting 360 and banjo bolt 370. A second washer 366 can be used between the liquid flow controller nozzle 368 and the banjo fitting 360. In one embodiment, both washers are copper. The cleaning solution enters the banjo fitting 360 through hose 264 which is connected to the inlet 362 of the banjo fitting 360. Those of ordinary skill in the art will be familiar with the proper use of banjo nuts and fittings.

The dispersion device 322 defines mixing chamber 382 that is open at the insertion end 325. Bored through the cylindrical side wall of the dispersion device 322 are several air inlet apertures 330. The air inlet apertures are preferably bored non-radially and sloped towards the opening of the dispersion device. In one embodiment, the apertures are sloped downward 39 degrees and 45 degrees from radial, but variations on this orientation are also suitable. The orientation of the apertures 330 creates a swirl of air within the mixing chamber 382. The swirl of air helps carry the droplets of cleaning solution into the air stream. The apertures 330 are sized to allow the engine to draw in just enough air to allow the engine to run without difficulty. In one embodiment, the dispersion device 322 has 12 apertures 330, each with a diameter of 0.15 inches.

The primary air intake adapter 540 is described with reference to FIGS. 13 and 14. The primary air intake adapter 540 includes a receiving section 560 and a primary air intake coupling section 570. The receiving section 560 is cylindrical in shape and defines a cylindrical receiving socket 542. The receiving socket 542 is configured to receive the insertion end 152 of the plug 150 or the insertion end 325 of the vacuum control device 300. A threaded hole 519 is disposed radially through the receiving section 560 in order to receive a thumbscrew 521. Once the insertion end 325 has been abutted against ridge 566, the device 300 is secured within the primary air intake adaptor 540 by screwing in the thumbscrew 521. The tip of the thumbscrew 521 engages the outer surface 327 of the insertion end 325 of the device 300. The device 300 is now securely held within the adapter 400. The insertion end 152 of the plug 150 is secured in the primary air intake adaptor 540 in substantially the same manner.

The primary air intake coupling section 570 defines a receiving socket that is the same shape, but slightly larger than the mouth 52 of the primary air intake 50. In most cases, the mouth 52 of the primary air intake 50 will be cylindrical. The primary air intake coupling section 570 is configured to slide over the mouth 52 of the primary air intake 50. Once the mouth 52 of the primary air intake 50 is slid inside the primary air intake coupling section 570, it is secured with three thumb screws 572, 574, and 576. Threaded holes 578, 580, and 582 are disposed radially through the primary air intake coupling section 570 in order to receive thumbscrews 572, 574, and 576.

Receiving section 560 and primary air intake coupling section 570 define an opening 590. The opening 590 allows cleaning solution to pass from the vacuum control device 300, into the receiving section 560, through the primary air intake coupling section 570 and then into the primary air intake 50.

Once a desired amount (e.g. a quart) of cleaning solution has been fed into the air intake system 100 through the EGR valve port 11, the portion of the plug 150 and the vacuum controller 300 are swapped. A second amount of cleaning solution is then fed through the vacuum controller 300, which, in the sequence illustrated herein, would be attached to the primary air intake adapter 540, which in turn is attached to the primary air intake 50. If the diesel engine contains more than one air intake system, then the process will need to repeated with the second EGR valve port (not shown) and the second primary air intake (not shown). Additionally, the cleaning process may be repeated from either opening if additional cleaning is required.

Once cleaning has been completed, the vacuum control device 300, the EGR valve port adapter 400, and the primary air intake adapter 540 are removed from the air intake system 100. This is done by removing the bolts 40 from the flange 15 surrounding the mouth of the EGR valve port 11. The EGR valve is then bolted back onto EGR valve port 11 using the bolts 40.

Because the EGR valve has been thoroughly cleaned manually (usually by soaking, scrubbing, scraping, etc.), and the EGR valve port 11 has been cleaned by the vacuum-controlled process described above, the entire system is completely cleaned and is ready to be returned to service with its operating condition being improved.

It has been determined that a particular cleaning solution is especially effective for use in the process described above. In one embodiment, the cleaning solution comprises five separate components. However, it should be noted that the device described above can effectively clean an engine with numerous solutions.

A first component in the cleaning solution is a solvent which should be highly polar. It is a well-understood principle that highly polar solvents are ideal for cleaning contaminants of high polarity. The typical soot, which accumulates on the air intake system and combustion chambers in a diesel vehicle, tends to have extremely high polarity. Thus, a highly polar solvent effectively removes these contaminates. The solvent used in one embodiment, is propylene carbonate (4-methyl-1,3-dioxolan-2-one) at 30 to 60 mass percent, and in another embodiment at 43% mass percent. Alternatively, closely-related highly-polar solvents ethylene carbonate and butylene carbonate may be used in this process. Mixtures of propylene carbonate, ethylene carbonate and butylenes carbonate could also be used and still fall within the scope of the invention.

Propylene carbonate has proved to be outstanding, not only because it is ideal for cleaning highly-polar contaminants, but also because of its combustibility properties. Propylene carbonate combusts well when run through a diesel system, unlike many other highly polar solvents. Not only does the propylene carbonate remove the deposits, but when used with the special equipment described in the application earlier, its chemistry does not significantly affect the combustion process. Another advantage is that propylene carbonate is relatively non-toxic and environmentally friendly.

Though propylene carbonate is used in this specific embodiment, other highly polar solvents, however, could be used as the first component of the cleaner as well. The use of any other highly polar solvent could be used so long as it is reasonably accepted by the diesel combustion in the vehicle engine. Thus, other highly-polar solvents could be used as the first component and still fall within the scope of the present invention.

In one embodiment, a second component is also included in the cleaning solution. The second component of the cleaner is a low polarity solvent at 30 to 60 mass percent, and in another embodiment at 43% mass percent. Preferably, the low polarity solvent would be included at a roughly equal proportion to the high polarity solvent described above.

The low-polarity solvent is added to the cleaner to more adequately dissolve low-end hydrocarbons present in the air intake system and combustion chamber. Aside from the extremely hard highly-polar contaminants clinging to the metal surfaces within the air intake and combustion systems, low-end hydrocarbons, such as oils and diesel fuels, are also re-circulated along with the exhaust in an EGR system. It is well known in the art that these low-end hydrocarbons are more easily removed with a low-polarity solvent. One example of a solvent that could be used effectively for such purposes is an aromatic solvent. Some examples of aromatic solvents that may be used effectively would be toluene, zylenes, cumenes, or any other low-polarity solvent that would not significantly impede the diesel combustion process. An aromatic solvent can be used that has a boiling range between 200 to 700 degrees Fahrenheit.

Surfactants may also be added as a third component to the formulation at 1 to 10 mass percent. In another embodiment, the surfactants are included at 3 mass percent. Surfactants enhance the cleaning of the harder baked-on deposits found on intake valves in the lower section of the air plenum as it meets the engine head. Surfactants also help the other chemistry penetrate and dissolve the deposits. Both non-ionic and ionic surfactants are suitable for inclusion in the formulation. However, non-ionic surfactants have been found beneficial. Ethoxylated linear secondary alcohols or mixtures of the same are effective non-ionic surfactants that could be included in the formulation.

The formulation may be further improved by the addition of a fourth component. The fourth component, in one embodiment, is a compound with functional ketone chemistry at 1-10 mass percent. In another embodiment, the functional ketone is included at 1-2 mass percent. In yet another embodiment, Cyclohexanone is used to provide the functional ketone chemistry. Cyclohexanone is an effective solvent that is water soluble. The water solubility of the Cyclohexanone and other solvents with functional ketone chemistry helps dissolve deposits that the other solvents might not effectively dissolve.

A fifth suggested component in the formulation is a fatty amide at 1 to 20 mass percent. In one embodiment, fatty amides are included at 10 mass percent. Fatty amides act as a dispersant and effectively remove fuel related deposits. In another embodiment, Hallcomid® M-10, N,N Dimethyldecanamide CAS# 14433-76-2 is used as the fatty amides. Other fatty amides work well, so long as they have good heat stability so they do not quickly decompose in the heat from the engine. Suitable fatty amides should also have good solubility with other solvents to be an effective component of the formulation.

The percentage by volume of propylene carbonate used within the formulation, preferably ranges from 30 to 60 percent of the overall volume. In one embodiment, propylene carbonate would comprise about 42 percent of the overall formulation. In this embodiment, the second low-polarity solvent would comprise approximately 43 percent of the formulation. The surfactant, fatty amide, and functional ketone chemistry will make up the balance.

For example, one embodiment of the formulation could be:
between 40 and 45 mass percent of propylene carbonate;
between 40 and 45 mass percent of toluene;
between 1 and 5 mass percent of a non-ionic surfactant;
between 5 and 15 mass percent Hallcomid® M-10, N,N
Dimethyldecanamide CAS# 14433-76-2; and
between 1 and 5 mass percent of Cyclohexanone.

It is important to note that, though first, second, third, fourth and fifth components have been included in the formulation illustrated here, any cleaning solution could be administered according to the claimed process and would still fall within the scope of this invention. Further, the first and second components could both be administered at separate times and still fall within the scope of this invention. The use of the third through fifth components is entirely optional, but does improve the cleaning process.

The solution is made by mixing the components together in a vessel with moderate agitation. When mixing the components, the aromatic solvent should be added prior to adding the propylene carbonate to assist the propylene carbonate with entering the solution. The order of adding the other components of the formulation does not effect the solution. In one embodiment, the formulation is made in a batch process with the entire amount of each component being added in full rather than in increments. Once all of the components are added the solution is agitated for about an hour. The components used in the specific embodiment disclosed herein readily form a solution. One having ordinary skill in the art will understand that the mixing time can be lengthened or shortened depending on the amount of agitation supplied. Moreover, multiple forms of agitation could be used including, but not limited to, recirculation pump systems or motorized mixing blades with or without a baffle. Once completed, the solution may be stored in tanks or totes. For final use, the solution may be further packaged into consumable sized portions. In one embodiment, the solution is packaged into quart sized consumable containers, and in another embodiment into F-style quart bottles.

In a further embodiment, a diesel engine may be cleaned entirely with chemicals when the air intake system is cleaned with the apparatus and solution described hereinabove, and an internal engine cleaner is added to the engine oil system whereby deposits are removed from a fuel injector hydraulic system. In this manner, the two areas of a diesel engine most susceptible to fouling are cleaned without labor intensive scrapping and with only minimal disassembly. Adding an internal engine cleaner to the engine oil is well known to those of ordinary skill in the art and for that reason is not described in detail herein.

Although the invention has been described with reference to the preferred features of various embodiments illustrated in the attached, and described in the above description, one skilled in the art will recognize that numerous substitutions could be made and the equivalents employed herein without departing from the scope of the invention, which is more properly defined as it is recited in the claims which, of course, are subject to amendment.

The invention claimed is:

1. A cleaning solution, comprising:
between 30 and 55 mass percent of a high polarity solvent;
between 30 and 55 mass percent of a low polarity solvent;
between 1 and 20 mass percent of a surfactant;
between 1 and 30 mass percent of fatty amide; and
between 1 and 20 mass percent of a functional ketone.

2. The cleaning solution of claim 1, wherein the high polarity solvent is selected from the group consisting of propylene carbonate, ethylene carbonate and butylenes carbonate.

3. The cleaning solution of claim 1, wherein the low polarity solvent comprises a aromatic solvent.

4. The cleaning solution of claim 1, wherein the surfactant is a non-ionic surfactant.

5. The cleaning solution of claim 1, wherein the functional ketone is Cyclohexanone.

6. A diesel engine air intake system cleaning solution, comprising:
between 40 and 45 mass percent of a high polarity solvent;
between 40 and 45 mass percent of a low polarity solvent;
between 1 and 5 mass percent of a surfactant;
between 5 and 15 mass percent of fatty amide; and
between 1 and 5 mass percent of a functional ketone.

7. The cleaning solution of claim 6, wherein the high polarity solvent is selected from the group consisting of propylene carbonate, ethylene carbonate and butylenes carbonate.

8. The cleaning solution of claim 6 wherein the low polarity solvent comprises a aromatic solvent.

9. The cleaning solution of claim 6, wherein the surfactant is a non-ionic surfactant.

10. The cleaning solution of claim 6, wherein the functional ketone is Cyclohexanone.

11. A method of cleaning a diesel engine, the diesel engine having an air intake system, the air intake system including an air inlet and an EGR valve port, the method comprising:
restricting the flow of air into the air intake system while the diesel engine is running, thereby lowering the pressure within the air inlet system; and
injecting a cleaning solution into the air steam entering at least one of the EGR valve port and the air inlet, the cleaning solution comprising between 30 and 55 mass percent of a high polarity solvent and between 30 and 55 mass percent of a low polarity solvent.

12. The method of claim 11, wherein the cleaning solution further comprises between 1 and 20 mass percent of a surfactant.

13. The method of claim 11, wherein the cleaning solution further comprises between 1 and 30 mass percent of fatty amide.

14. The method of claim 11, wherein the cleaning solution further comprises between 1 and 20 mass percent of a functional ketone.

15. The method of claim 11, wherein the high polarity solvent is selected from the group consisting of propylene carbonate, ethylene carbonate and butylenes carbonate.

16. The method of claim 11, wherein the low polarity solvent is a aromatic solvent.

17. The method of claim 12, wherein the surfactant is a non-ionic surfactant.

18. A method of manufacturing a cleaning solution in a vessel, the method comprising:
adding an aromatic solvent at between 30 and 55 mass percent of a final batch formulation;
adding a fatty amide between 1 and 30 mass percent of a final batch formulation;
adding a surfactant between 1 and 20 mass percent of a final batch formulation;
adding a functional ketone between 1 and 20 pass percent of a final batch formulation; and
adding a highly polar solvent in roughly equal mass proportion to the aromatic solvent, whereby the highly polar solvent is added after the aromatic solvent.

19. The method of claim 18, wherein the highly polar solvent is selected from the group consisting of propylene carbonate, ethylene carbonate and butylenes carbonate.

20. The method of claim 18, wherein the surfactant is a non-ionic surfactant.
